(19) United States
(12) Patent Application Publication
(10) Pub. No.: US 2010/0128817 A1
(43) Pub. Date: May 27, 2010

(54) WIRELESS RECEIVER AND METHOD OF SAVING POWER

(76) Inventors: Desmond Philips, Cambridge (GB); Bryan James Donoghue, Cambridge (GB); Matthew Hayes, Cambridge (GB)

Correspondence Address: REED SMITH LLP, P.O. BOX 488, PITTSBURGH, PA, 15230-0488, US

(21) Appl. No.: 12/377,584

(22) PCT Filed: Aug. 17, 2007
(86) PCT No.: PCT/GB07/03127

§ 371 Date: Apr. 3, 2009

(30) Foreign Application Priority Data
Aug. 18, 2006 (GB) 0616518.7

(51) Int. Cl. H04L 27/00; H04B 1/16

(52) U.S. Cl. 375/316; 455/343.1

(57) ABSTRACT

A receiver (10) for receiving a wireless communication signal, such as a UWB signal, is operable in a first mode when the receiver is actively receiving a transmitted signal, and a second mode when the receiver is waiting to receive a transmitted signal. The receiver comprises an analogue-to-digital converter (20) for converting a received analogue signal into a digital signal. A receiver controller is adapted to control the operating resolution of the analogue to digital converter such that, in the first mode, the analogue-to-digital converter (20) operates at a first resolution, and, in the second mode, the analogue-to-digital converter (20) operates at a second resolution. The second resolution is lower than the first resolution, and preferably the second resolution is a 1-bit resolution.

### TECHNICAL FIELD OF THE INVENTION

The invention relates to a wireless receiver and a method of saving power in a wireless receiver, and in particular to an ultra-wideband (UWB) receiver and method using a power-saving analogue-to-digital converter with switchable resolution.

### BACKGROUND OF THE INVENTION

Ultra-wideband is a radio technology that transmits digital data across a very wide frequency range, 3.1 to 10.6 GHz. It makes use of ultra low transmission power, typically less than −41 dBm/MHz, so that the technology can literally hide under other transmission frequencies such as existing Wi-Fi, GSM and Bluetooth. This means that ultra-wideband can co-exist with other radio frequency technologies. However, this has the limitation of limiting communication to distances of typically 5 to 20 metres.

There are two approaches to UWB: the time-domain approach, which constructs a signal from pulse waveforms with UWB properties, and a frequency-domain modulation approach using conventional FFT-based Orthogonal Frequency Division Multiplexing (OFDM) over Multiple (frequency) Bands, giving MB-OFDM. Both UWB approaches give rise to spectral components covering a very wide bandwidth in the frequency spectrum, hence the term ultra-wideband, whereby the bandwidth occupies more than 20 per cent of the centre frequency, typically at least 500 MHz.

These properties of ultra-wideband, coupled with the very wide bandwidth, mean that UWB is an ideal technology for providing high-speed wireless communication in the home or office environment, whereby the communicating devices are within a range of 20 m of one another.

FIG. 1 shows the arrangement of frequency bands in a multi-band orthogonal frequency division multiplexing (MB-OFDM) system for ultra-wideband communication. The MB-OFDM system comprises fourteen sub-bands of 528 MHz each, and uses frequency hopping every 312 ns between sub-bands as an access method. Within each sub-band OFDM and QPSK or DCM coding is employed to transmit data. It is noted that the sub-band around 5 GHz, currently 5.1-5.8 GHz, is left blank to avoid interference with existing narrowband systems, for example 802.11a WLAN systems, security agency communication systems, or the aviation industry.

The fourteen sub-bands are organized into five band groups: four having three 528 MHz sub-bands, and one having two 528 MHz sub-bands. As shown in FIG. 1, the first band group comprises sub-band 1, sub-band 2 and sub-band 3. An example UWB system will employ frequency hopping between sub-bands of a band group, such that a first data symbol is transmitted in a first 312.5 ns duration time interval in a first frequency sub-band of a band group, a second data symbol is transmitted in a second 312.5 ns duration time interval in a second frequency sub-band of a band group, and a third data symbol is transmitted in a third 312.5 ns duration time interval in a third frequency sub-band of the band group. Therefore, during each time interval a data symbol is transmitted in a respective sub-band having a bandwidth of 528 MHz, for example sub-band 2 having a 528 MHz baseband signal centred at 3960 MHz.

The basic timing structure of a UWB system is a superframe. A superframe consists of 256 medium access slots (MAS), where each MAS has a defined duration, for example 256 μs. Each superframe starts with a Beacon Period, which lasts one or more contiguous MASs. The start of the first MAS in the beacon period is known as the “beacon period start”.

The technical properties of ultra-wideband mean that it is being deployed for applications in the field of data communications. For example, a wide variety of applications exist that focus on cable replacement in the following environments:
communication between PCs and peripherals, i.e. external devices such as hard disc drives, CD writers, printers, scanner, etc.
home entertainment, such as televisions and devices that connect by wireless means, wireless speakers, etc.
communication between handheld devices and PCs, for example mobile phones and PDAs, digital cameras and MP3 players, etc.

Receivers for MB-OFDM UWB links require a very fast analogue-to-digital converter (ADC) with high resolution. A typical ADC for this link will capture a pair of (I,Q) samples at 528 MHz, with a resolution of six bits for each sample. The power consumption of the ADC increases with increasing sample rate. The power consumption of the ADC also increases exponentially with sample resolution, since the ADC will be a flash converter where power consumption is proportional to the number of comparators, and the number of comparators is proportional to 2^{resolution}. The power consumption of two 528 MHz ADCs with six bits of resolution will therefore be very high.

MB-OFDM UWB will be used in portable devices where low power consumption is very important. It is desirable that the UWB receiver within these devices operates continuously, so that it is able to receive frames transmitted by other devices. However, if the UWB receiver operates continuously, this will place an unacceptable load on the power supply, i.e. battery, of a portable device, because the receiver ADC will consume too much power.

The problem of the ADC consuming too much power can be mitigated using two known strategies:
1. The user might be required to switch on the receiver during periods when communication takes place, and then switch off the receiver following communication. This solution is undesirable because frames may be missed if the user does not switch on the receiver. Additionally power may be wasted if the user does not switch off the receiver.
2. The receiver can enter a “snooze” mode if no frames have been received for some time. The receiver can then wake up periodically to sense for frame activity. This solution is not ideal since the receiver may miss frames while it is “snoozing”.

It is an aim of the present invention to provide an improved wireless receiver, and a method of saving power in a wireless receiver.

### SUMMARY OF THE INVENTION

According to the present invention, there is provided a receiver for receiving a wireless communication signal, the receiver being operable in a first mode when the receiver is actively receiving a transmitted signal, and a second mode when the receiver is waiting to receive a transmitted signal. The receiver comprises an analogue to digital converter for converting a received analogue signal into a digital signal; and a receiver controller, adapted to control the operating resolution of the analogue to digital converter such that, in the first mode, the analogue to digital converter operates at a first resolution, and, in the second mode, the analogue to digital converter operates at a second resolution, wherein the second resolution is lower than the first resolution.

According to another aspect of the present invention, there is provided a method of saving power in a receiver having an analogue-to-digital converter for converting a received analogue signal into a digital signal. The method comprises the steps of operating the receiver in a first mode when the receiver is actively receiving a transmitted signal; and operating the receiver in a second mode when the receiver is waiting to receiving a transmitted signal. The analogue-to-digital converter has a first resolution when operating in the first mode, and a second resolution when operating in the second mode, the second resolution being lower than the first resolution.

The invention has the advantage of enabling the average power consumption of a UWB receiver to be reduced by placing the receiver in a low-power “listening” mode when it is not actively receiving a frame. In the “listening” mode, the RF and the detection correlator are active, and the ADC is placed in a low-power, low-resolution mode. Once the detection correlator detects the presence of a preamble symbol at the start of a frame, the receiver is powered-up and the ADC placed in a high-resolution mode. At the end of the frame (or at the end of the last frame of a burst of frames), the receiver may be returned to the “listening” mode.

### BRIEF DESCRIPTION OF THE DRAWINGS

For a better understanding of the present invention, and to show more clearly how it may be carried into effect, reference will now be made, by way of example only, to the following drawings in which:

FIG. 1 shows the multi-band OFDM alliance (MBOA) approved frequency spectrum of a MB-OFDM system;

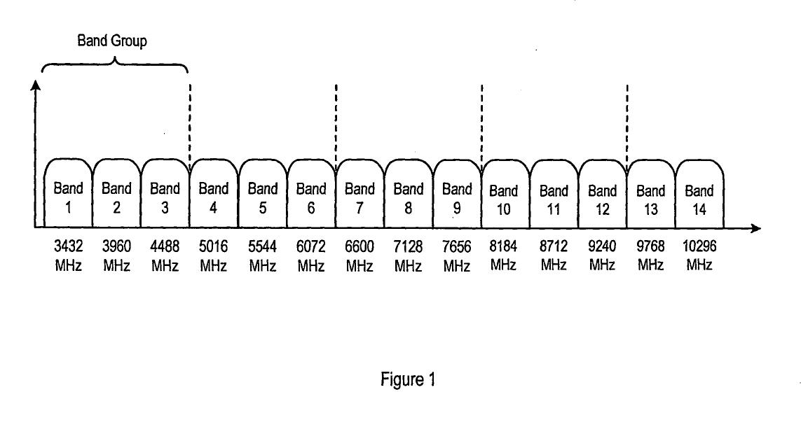

FIG. 2 is a block schematic diagram of a receiver according to the present invention.

FIG. 3 is a flow chart detailing the steps performed by the present invention.

### DETAILED DESCRIPTION OF A PREFERRED EMBODIMENT OF THE PRESENT INVENTION

The following description of the preferred embodiment is made in relation to a UWB receiver. However, it will be appreciated that the invention is also applicable to other types of wireless receivers, including UWB receivers adapted for use in standards other than the MB-OFDM standard.

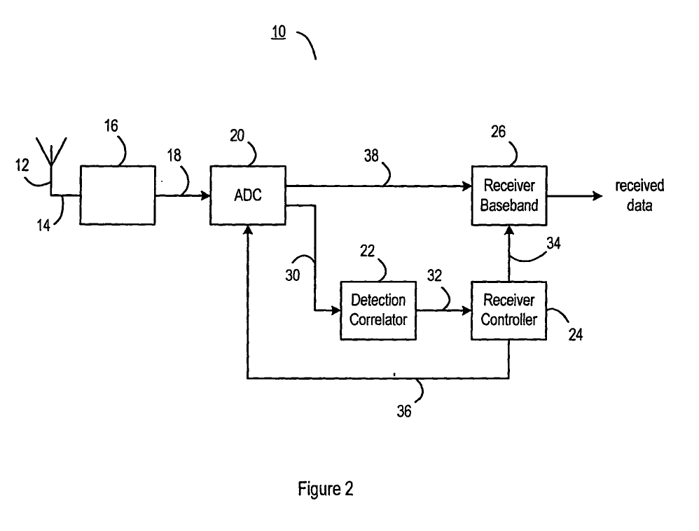

FIG. 2 shows a block schematic diagram of a receiver 10 according to the present invention.

The receiver 10 comprises an antenna 12 which receives an RF signal 14. An RF section 16 amplifies the received signal 14, and outputs the amplified signal 18 to an analogue-to-digital converter 20.

The receiver 10 further comprises a detection correlator 22, a receiver controller 24, and a receiver baseband 26.

The receiver 10 has two operating modes: the “receiving” mode (or first mode) in which the receiver operates in a normal mode of operation (i.e. when receiving UWB signals from one or more other UWB devices), and a “listening” mode (or second mode) in which the receiver operates in a power saving mode according to the invention (for example when waiting to receive UWB signals from one or more other UWB devices).

While operating in the receiving mode, all sections of the receiver 10 are switched on, and the ADC 20 operates at a high resolution, for example a six bit resolution. The high-resolution output 38 is sent directly from the ADC 20 to the receiver baseband 26. It will be appreciated that, although the preferred embodiment refers to the high resolution of the ADC 20 being six bits per sample, other resolutions may also be used.

According to the invention, the receiver controller 24 is adapted to place the receiver 10 in a listening mode to conserve power. For example, the receiver 10 can be placed in the listening mode at the end of a frame, or after the last frame of a burst of frames.

In the listening mode, the receiver baseband 26 and all other non-essential sections (not shown in FIG. 2) are placed in a power-save mode, for example switched off, thereby reducing the power consumption of the receiver 10. The RF section 16, ADC 20, detection correlator 22 and receiver controller 24 remain switched on, although the power consumption of these blocks may be reduced from normal operation.

However, according to the invention, the ADC 20 is configured to operate at a low resolution when the receiver is in the listening mode. For example, in a preferred embodiment, the low resolution is 1-bit for each sample. The power consumption of the ADC 20 is reduced when operating in the 1-bit resolution mode because fewer comparators will be active, thereby further reducing the power consumption of the receiver 10 as a whole.

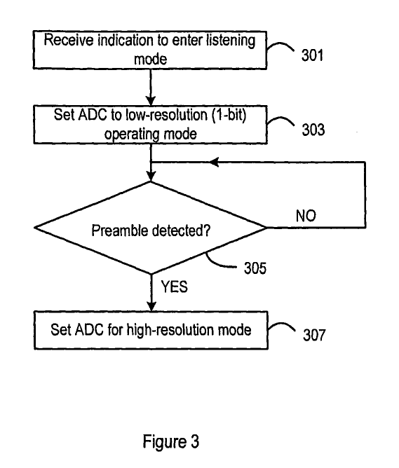

The flow diagram of FIG. 3 describes the basic principles regarding how the invention controls the operation of the receiver between a normal operating mode, i.e. the receiving mode, and the low power mode, i.e. the listening mode.

Upon receiving an indication to enter the listening mode, for example an end of frame signal or after the last frame of a burst of frames, step 301, the receiver is adapted to place the ADC 20 in a low resolution mode of operation, step 303. Preferably, the low resolution mode of operation is a 1-bit mode of operation. While in the listening mode, the receiver is adapted to detect the presence of a preamble signal based on the 1-bit output of the ADC 20, step 305. If no preamble is detected, the receiver remains in the listening mode, and the ADC 20 in the 1-bit mode. However, upon detection of a preamble signal, the ADC is set to the high resolution mode once more, step 307.

Thus, whilst in the listening mode, if a frame is transmitted by another device it will be amplified by the receiver RF section 16 and then passed to-the ADC 20. The output of the ADC is then passed to the detection correlator 22. The detection correlator 22 is able to reliably detect the presence (or absence) of a frame preamble symbol, based on the information from a 1-bit sample of the received signal 30. When the receiver controller 24 receives a “preamble present” signal 32 from the detection correlator 22, the receiver controller 24 will immediately wake up all sections of the receiver 10 and place the ADC 20 into the high-resolution mode, so that the receiver 10 is placed in the “receiving mode”, and thus able to receive the incoming frame. This is achieved by sending a “power-save” signal 34 to the receiver baseband 26, instructing the baseband 26 to exit power-save mode and power up, and sending a “resolution control” signal 36 to the ADC 20, instructing the ADC to operate at a high resolution.

At the end of the frame or at the end of the last frame in a frame burst, the receiver controller 24 sends a power-save signal 34 to the receiver Baseband 26, instructing the receiver 10 to enter the power-save mode, and sends a resolution-control signal to the ADC 20, instructing the ADC 20 to operate at the lower resolution. Thereafter, the receiver 10 re-enters the listening mode.

The listening or power-save mode may be achieved, for example, by clock-gating the digital logic within the receiver baseband 26. Clock-gating temporarily disables clocks to registers within inactive digital logic. This significantly reduces the power consumption of the inactive digital logic. However, a person skilled in the art will appreciate that many other possible methods for achieving a power-save mode can be provided without departing from the scope of the present invention.

As can be seen from the above, the invention relies on the detection correlator 22 being able to reliably detect the presence of a preamble symbol in the received signal, and thereafter the receiver 10 being able to switch to receiving mode relatively quickly so that as little information is lost as possible. The invention is made possible by the fact that the preamble found in a UWB signal is relatively long. For example, the standard MB-OFDM signal includes 24 preamble symbols. However, it is possible to correctly receive a frame using fewer of these preamble symbols, say only 18 of the preamble symbols. In such a scenario, the receiver 10 can therefore afford to lose the first 6 preamble symbols of each packet. If the detection correlator 22 detects the presence of the first preamble symbol then the remainder of the receiver 10 must power-up within 5 preamble symbols (i.e. 1.5625 μs).

This enables the preamble to be detected reliably using just 1-bit resolution. For example, the 1-bit detection correlator sums how often the sign of the samples in a sliding window (equal to the length of the preamble symbol) coincides with the sign of the expected preamble signal. When this sum is compared to a pre-computed threshold, a reliable decision on the presence or absence of an MB-OFDM preamble can be made. The threshold is chosen (by modelling the statistics of the detection correlator) to achieve certain false alarm and missed frame probabilities.

The above mentioned characteristics of the preamble enable the receiver to be placed in the receiving mode without losing any data.

The ADC 20 can rapidly switch between high and low resolutions, as this merely involves powering up the necessary extra comparators, for switching to the high resolution, or powering down the unnecessary comparators, for switching to the low resolution. In addition, the receiver baseband 26 can also switch rapidly between an operational mode and a power-save mode, for example by employing clock-gating as mentioned above.

Further modifications to the receiver 10 will be apparent to the person skilled in the art. For example, the preamble-detection function of the detection correlator 22 could be replaced by an RF power detection circuit. Such a circuit would infer the presence of a transmitted signal by detecting radio-frequency power in the received signal. This is a sub-optimal solution, as the RF power detection circuit will not be able to distinguish between preamble symbols and other radio communications. However, such a system would employ the same inventive concept as the present invention, and is therefore to be considered as falling within the scope of the invention as defined in the appended claims.

In addition to changing the resolution of the ADC during the listening mode; the receiver can also be adapted to change the resolution of the ADC during the receiving mode, for example depending on the quality of the signal being received. The ADC 20 may be configured to operate at a lower resolution, such as 3-bit, 4-bit or 5-bit, when a high quality signal is being received, and to operate at a 6-bit mode of operation when a poor quality signal is being received.

It is noted that the invention may also be used with non-wireless systems where a power saving mode by reducing the accuracy of the ADC is advantageous.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1-21. (canceled)

22. A multiple mode receiver, comprising:
a multiple resolution analogue to digital converter; and
a receiver controller communicably connected to the analogue to digital converter.

23. The receiver of claim 22, wherein the receiver is configured to operate in:
a first mode when all sections of the receiver are switched on; and
a second mode when at least one of the sections of the receiver is switched off.

24. The receiver of claim 22, wherein the receiver is a wireless receiver.

25. The receiver of claim 22, wherein the analogue to digital converter is configured to operate at:
a first resolution when the receiver is in a first mode of operation; and
a second resolution when the receiver is in a second mode of operation.

26. The receiver of claim 25, wherein the second resolution is less than the first resolution.

27. The receiver of claim 26, wherein the analogue to digital converter is further configured to operate at a third resolution when the receiver is in the first mode of operation, wherein the third resolution is greater than the second resolution.

28. The receiver of claim 22, wherein the analogue to digital converter is configured to operate at:
a first resolution when a preamble symbol is present in a received signal; and
a second resolution when the received signal is void of at least one preamble symbol.

29. The receiver of claim 28, wherein the second resolution is less than the first resolution.

30. The receiver of claim 29, wherein the analogue to digital converter is further configured to operate at a third resolution when the receiver is in the first mode of operation, wherein the third resolution is greater than the second resolution.

31. The receiver of claim 22, wherein the receiver controller is configured to instruct the analogue to digital converter to operate at one of the following:
a first resolution; and
a second resolution.

32. The receiver of claim 22, further comprising a detection correlator communicably connected to:
the analogue to digital converter; and
the receiver controller.

33. The receiver of claim 22, wherein the detection correlator is configured to detect a preamble symbol received from the analogue to digital converter.

34. The receiver of claim 22, further comprising a radio frequency power detection circuit communicably connected to the receiver controller.

35. The receiver of claim 22, further comprising a receiver baseband communicably connected to:
the analogue to digital converter; and
the receiver controller.

36. A method, comprising:
operating a receiver in a first mode when all sections of the receiver are switched on; and
operating the receiver in a second mode when at least one of the sections of the receiver is switched off.

37. The method of claim 36, wherein:
operating the receiver in the first mode comprises operating an analogue to digital converter at a first resolution; and
operating the receiver in the second mode comprises operating the analogue to digital converter at a second resolution, wherein the second resolution is lower than the first resolution.

38. The method of claim 37, wherein operating the analogue to digital converter at the first resolution comprises operating the analogue to digital converter at any of the following:
a 3-bit resolution;
a 4-bit resolution;
a 5-bit resolution; and
a 6-bit resolution.

39. The method of claim 38, further comprising changing the first resolution of the analogue to digital converter when the receiver is operating in the first mode.

40. The method of claim 37, wherein operating the analogue to digital converter at the second resolution comprises operating the analogue to digital converter at a 1-bit resolution.

41. The method of claim 37, further comprising detecting a presence of at least one preamble symbol in an output signal of the analogue to digital converter.

42. The method of claim 41, wherein detecting the presence of the at least one preamble symbol comprises:
increasing a sum when a sign of a sample in a sliding window and a sign of an expected preamble symbol coincide; and
comparing the sum to a predetermined threshold.

43. The method of claim 41, further comprising instructing the analogue to digital converter to operate at the first resolution when the presence of the preamble symbol is detected.

44. The method of claim 37, further comprising detecting a radio frequency power level of a received signal.

45. The method of claim 44, further comprising instructing the analogue to digital converter to operate at the first resolution when the detected radio frequency power level exceeds a predetermined threshold.

46. The method of claim 36, further comprising instructing a receiver baseband to enter into a power-save mode.
